(19) United States
(12) Patent Application Publication
(10) Pub. No.: US 2007/0046599 A1
(43) Pub. Date: Mar. 1, 2007

(54) Display driving apparatus and method for reducing block dim and display device comprising the display driving apparatus

(75) Inventors: Kyung-Myun Kim, Seoul (KR); Kyeong-Tae Moon, Yongin-si (KR); Byung-Hun Han, Seoul (KR); Sang-Hun Kim, Seoul (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/324,036

(22) Filed: Dec. 30, 2005

(30) Foreign Application Priority Data
Aug. 30, 2005 (KR) 10-2005-0079717

(51) Int. Cl. G09G 3/36

(52) U.S. Cl. 345/89

(57) ABSTRACT

A display device includes a display panel having a plurality of scan lines and a plurality of data lines, and a plurality of display panel driving apparatuses. Each of the display panel driving apparatuses includes a data line driving circuit, and a plurality of pads via which corresponding gray-scale voltages are respectively output. The data line driving circuit drives corresponding data lines of the plurality of the data lines. Each of the plurality of the pads outputs a corresponding gray-scale voltage of a plurality of gray-scale voltages, wherein the pads of the display panel driving apparatuses are connected in a cascade. The pads of the display panel driving apparatuses may be connected via a flexible printed circuit.

### CROSS-REFERENCE TO RELATED APPLICATIONS

This application claims priority to Korean Patent Application No. 10-2005-0079717, filed on Aug. 30, 2005, the disclosure of which is herein incorporated by reference in its entirety.

### BACKGROUND OF THE INVENTION

1. Technical Field

The present invention relates to a display driving apparatus and, more particularly, to a display driving apparatus for reducing a block dim and a display device comprising a plurality of display driving apparatuses.

2. Description of the Related Art

Small to medium-sized thin-film transistor liquid crystal display (TFT-LCD) apparatuses having QVGA resolution (QVGA=320×240 pixels) or a higher resolution typically use a plurality of TFT-LCD driving ICs that are connected in a cascade, for example, ICs 16 and 24 as illustrated in FIG. 1.

FIG. 1 is a block diagram illustrating a conventional TFT-LCD apparatus 10 comprising the TFT-LCD driving ICs 16 and 24. FIG. 2 is a circuit diagram illustrating a gray-scale voltage generator 20 included in the TFT-LCD driving IC 16 of FIG. 1.

Referring to FIGS. 1 and 2, the TFT-LCD apparatus 10 includes a TFT-LCD panel 14 and the TFT-LCD driving ICs 16 and 24 mounted on a glass substrate 12, and a flexible printed circuit (FPC) on which wirings for connecting the TFT-LCD panel 14 to the TFT-LCD driving ICs 16 and 24 and an external device (not shown) are mounted.

The TFT-LCD driving IC 16 includes a gate driver, a controller, a power source, and a source driver 18. The source driver 18 includes the gray-scale voltage generator 20, and a 480-channel source driver 22. The driving IC 24 includes a gate driver, a controller, a power source, and a source driver 26. The source driver 26 includes a gray-scale voltage generator 28, and a 480-channel source driver 30. The gray-scale voltage generator 20 of the TFT-LCD driving IC 16 and is configured the same as the gray-scale voltage generator 28 of the TFT-LCD driving IC 24.

As illustrated in FIG. 2, the gray-scale voltage generator 20 of the TFT-LCD driving IC 16 includes a plurality of buffers 20-1 through 20-8. The buffers 20-1 through 20-8 receive and buffer corresponding gamma-adjusted reference voltages VINPi/VINNi (i is an integer from 0 to 7), and generate the 64 gray-scale voltages V0 through V63 using corresponding resistors R, respectively.

Each of the 480-channel source drivers 22 and 30 selects one of the 64 gray-scale voltages V0 through V63 based on image data DATA, and outputs analog signals S1 through S480 corresponding to the image data DATA to data lines of the TFT-LCD panel 14.

It can be preferable that the TFT-LCD driving ICs 16 and 24 have the same construction and function, and that the analog signal Si (i=1−480) output from the TFT-LCD driving IC 16 and the analog signal Si (i=1−480) output from the TFT-LCD driving IC 24 are at the same logic levels. However, the logic levels of the analog signal Si output from the TFT-LCD driving IC 16 and the analog signal Si output from the TFT-LCD driving IC 24 may be different from one another according to a variation in a process, temperature, or a voltage.

For example, the gray-scale voltage Vi (i=0−63) generated by the gray-scale voltage generator 20 of the TFT-LCD driving IC 16, may be different from the gray-scale voltage Vi (i=0−63) generated by the gray-scale voltage generator 28 of the TFT-LCD driving IC 24 according to a change in a process, temperature, or a voltage in the buffers 20-1 through 20-8 of the TFT-LCD driving ICs 16 and 24. In this case, the signal Si output from the 480-channel source driver 22 based on a corresponding one of the gray-scale voltage Vi generated by the gray-scale voltage generator 20, will be different from the signal Si output from the 480-channel source driver 30 based on a corresponding one of the gray-scale voltages Vi generated by the gray-scale voltage generator 28.

The difference between the signal Si, for example, S100, output from the TFT-LCD driving IC 16 and the signal Si, for example, S100, output from the TFT-LCD driving IC 24 can cause a difference in luminance between an image displayed in an area A 14-1 and an image displayed in an area B 14-2, even when the same image data DATA is input to each of the TFT-LCD driving ICs 16 and 24 of the TFT-LCD apparatus 10 in response to the signal S100. The different luminance caused by the differences between the gray-scale voltages Vi of the gray-scale generator 20 of the TFT-LCD driving IC 16 and the gray-scale voltage Vi of the gray-scale generator 28 of the TFT-LCD driving IC 24, is referred to as a ‘block dim.’

The block dim occurrence in the TFT-LCD apparatus can deteriorate the quality of an image on a display device and reduce the yield of the TFT-LCD driving ICs.

### SUMMARY OF THE INVENTION

Exemplary embodiments of the present invention provide a display driving apparatus for reducing a block dim, and a display device comprising-a plurality of display driving apparatuses.

According to an aspect of the present invention, there is provided a display panel driving apparatus to drive a plurality of scan lines and a plurality of data lines of a display panel. The display panel driving apparatus includes a scan line driving circuit to drive the plurality of the scan lines, a data line driving circuit to drive the plurality of the data lines based on image data, and a controller to control the scan line driving circuit and the data line driving circuit.

In an exemplary embodiment of the present invention, the data line driving circuit comprises: a gray-scale voltage generator to buffer a plurality of reference voltages and output a plurality of gray-scale voltages via a plurality of output terminals; and a channel source driver to select one of the gray-scale voltages based on image data, generate analog voltages corresponding to the image data, and apply the generated analog voltages to the data lines.

In an exemplary embodiment of the present invention, the gray-scale voltage generator comprises: a plurality of pads, wherein each of the pads outputs a gray-scale voltage, and wherein each of the pads is connected to a corresponding output terminal of the plurality of output terminals.

In an exemplary embodiment of the present invention, the gray-scale voltage generator comprises: a plurality of buffers, wherein each of the buffers buffers a reference voltage, and a plurality of resistors, wherein each of the resistors is connected between a buffer output terminal of a corresponding buffer of the plurality of the buffers and a corresponding output terminal of the plurality of the output terminals.

According to another aspect of the present invention, there is provided a display device comprising a display panel including a plurality of scan lines and a plurality of data lines, and a plurality of display panel driving apparatuses. Each of the display panel driving apparatuses comprises: a data line driving circuit to drive corresponding data lines of the plurality of the data lines, and a plurality of pads, wherein each of the pads outputs a gray-scale voltage, and wherein the pads of each of the display panel driving apparatuses are connected in a cascade. The plurality of the pads of each of the display panel driving apparatuses may be connected via a flexible printed circuit.

According to yet another aspect of the present invention, there is provided a display device comprising a display panel including a plurality of scan lines and a plurality of data lines, a first display panel driving apparatus, and second display panel driving apparatus. The first display panel driving apparatus includes pads, wherein each of the pads outputs a gray-scale voltage, and a data line driving circuit to drive a plurality of first data lines of the plurality of the data lines. The second display panel driving apparatus includes pads, wherein each of the pads outputs a gray-scale voltage, and a data line driving circuit to drive a plurality of second data lines of the plurality of the data lines. The pads of the first display panel driving apparatus are respectively connected to the pads of the second display panel driving apparatus.

According to still another aspect of the present invention, there is provided a method of reducing a block dim in a display device. The method includes a display panel having a plurality of scan lines and a plurality of data lines, and a plurality of display panel driving apparatuses, each having a plurality of corresponding pads. The method includes connecting the pads of the plurality of the display panel driving apparatuses in a cascade, and using the plurality of the display panel driving apparatus, driving corresponding scan lines of the plurality of the scan lines and corresponding data lines of the plurality of the data lines.

### BRIEF DESCRIPTION OF THE DRAWINGS

The present invention will become more apparent to those of ordinary skill in the art when descriptions of exemplary embodiments thereof are read with reference to the accompanying drawings, of which:

FIG. 1 is a block diagram of a conventional thin film transistor-liquid crystal display (TFT-LCD) apparatus having TFT-LCD driving integrated circuits (ICs).

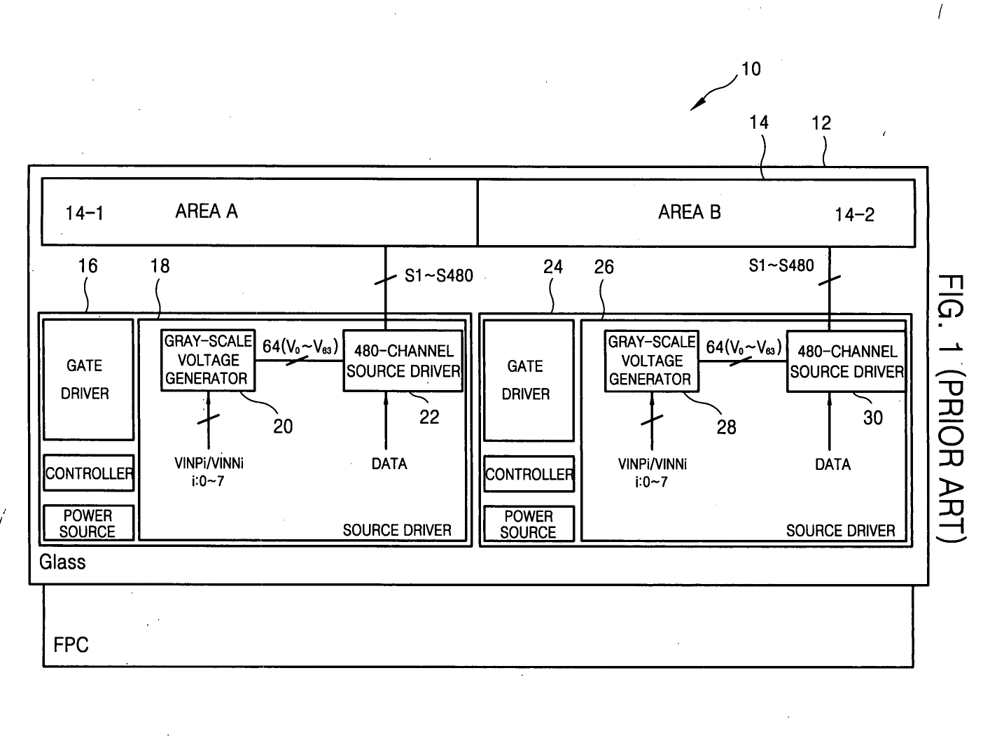

FIG. 2 is a circuit diagram of a gray-scale voltage generator of each TFT-LCD driving IC of FIG. 1.

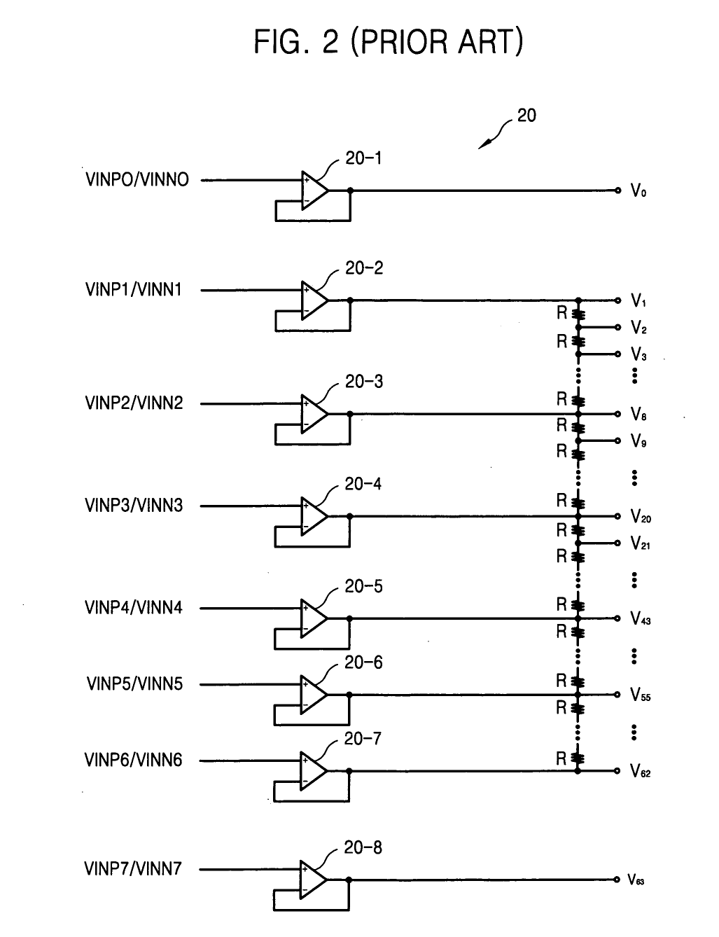

FIG. 3 is a block diagram illustrating the internal construction of a display panel driving apparatus with a gray-scale voltage generator according to an exemplary embodiment of the present invention.

FIG. 4 is a circuit diagram of the gray-scale voltage generator of FIG. 3.

FIG. 5 is a block diagram of a display device with two display panel driving apparatuses according to an exemplary embodiment of the present invention.

FIG. 6 is a block diagram of a display device with four display panel driving apparatuses according to an exemplary embodiment of the present invention.

### DETAILED DESCRIPTION OF THE EXEMPLARY EMBODIMENTS

Hereinafter, exemplary embodiments of the present invention will be described in detail with reference to the accompanying drawings. Like reference numerals refer to similar or identical elements throughout the description of the figures.

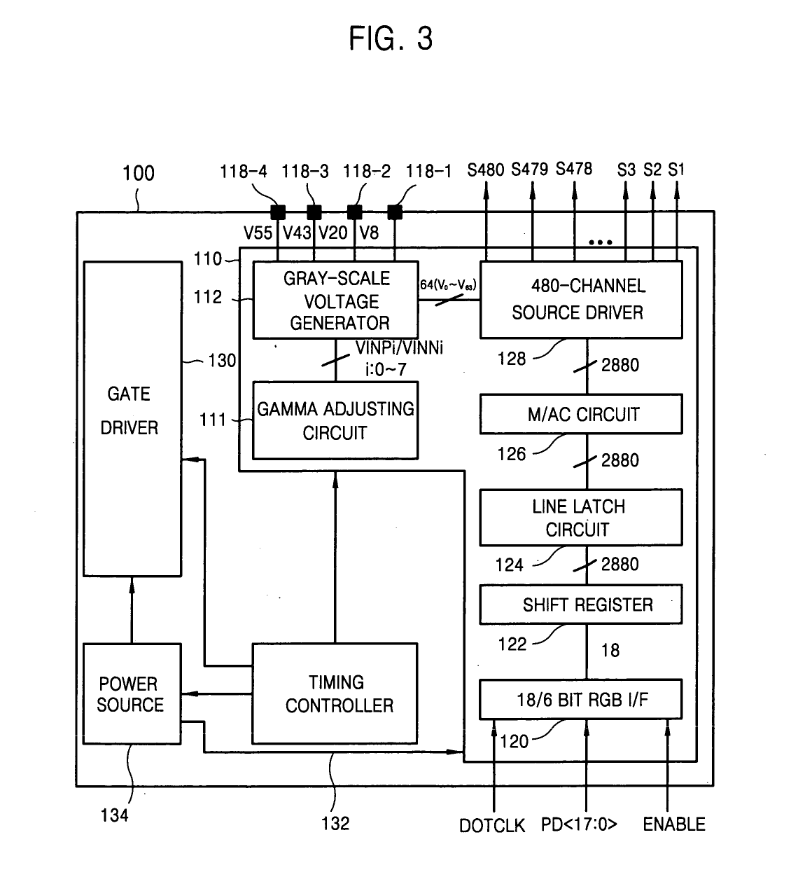

FIG. 3 is a block diagram illustrating the internal construction of a display panel driving apparatus 100 with a gray-scale voltage generator 112 according to an exemplary embodiment of the present invention. As illustrated in FIG. 3, the display panel driving apparatus 100 may be fabricated with an integrated circuit (IC).

The display panel driving apparatus 100 includes a data line driving circuit 110 (or a source driver), a scan line driving circuit 130 (or a gate driver), a timing controller 132, and a power source 134.

The data line driving circuit 110 generates signals Si through S480 for driving data lines of a display panel (not shown) based on image data PD<17:0> in an active section of an enable signal ENABLE. As well known in the art, the display panel includes a plurality of data lines (or source lines), a plurality of scan lines (or gate lines), and liquid crystal.

The data line driving circuit 110 includes a gamma adjusting circuit 111, the gray-scale voltage generator 112, an 18/6-bit RGB interface 120, a shift register 122, a line latch circuit 124, an M/AC circuit 126, and a 480-channel source driver 128.

The gamma adjusting circuit 111 generates gamma-adjusted eight reference voltages VINPi/VINNi (i is an integer, for example, from 0 to 7), for example, VINP0/VINN0, VINP1/VINN1 and so on.

The gray-scale voltage generator 112 buffers each of the reference voltages VINPi/VINNi, outputs 64 gray-scale voltages V0 through V63 to the 480-channel source driver 128 via corresponding output terminals (not shown). The gray-scale voltage generator 112 outputs the gray-scale voltages, for example, V8, V20, V43, and V55, via pads 118-1, 118-2, 118-3, and 118-4.

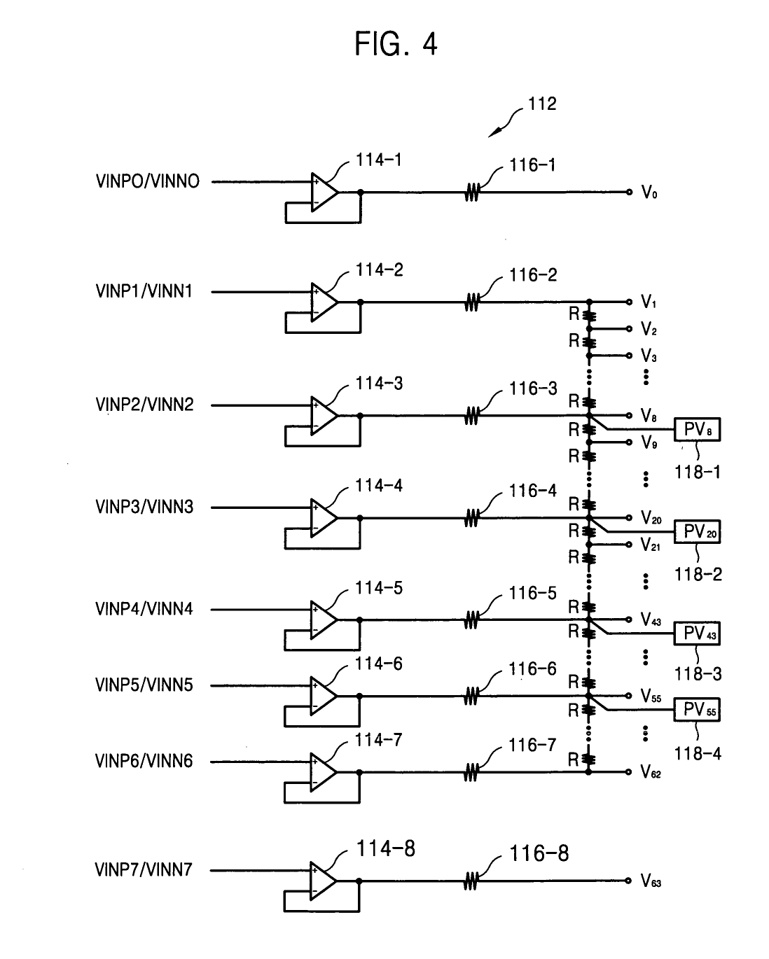

FIG. 4 is a circuit diagram of the gray-scale voltage generator 112 of FIG. 3 according to an exemplary embodiment of the present invention. Referring to FIG. 4, the gray-scale voltage generator 112 includes a plurality of buffers 114-1 through 114-8, a plurality of resistors 116-1 through 116-8, a plurality of pads 118-1 through 118-4 via which the corresponding gray-scale voltages, for example, V8, V20, V43, and V55 are respectively output, and a plurality of output terminals (not shown). The gray-scale voltages V0 through V63 are output via the output terminals.

The buffers 114-1 through 114-8, which may use an operational amplifier, receive and buffer a plurality of reference voltages VINPi/VINNi (i is an integer, for example, from 0 to 7) output from the gamma adjusting circuit 111 of FIG. 3, and output buffered signals, respectively.

Each of the resistors 116-1 through 116-8, respectively, is connected between the buffer output terminal of a corresponding buffer 114-1 through 114-8 and a corresponding output terminal (not shown).

Each of the pads 118-1 through 118-4, respectively, is connected to a corresponding voltage-output terminal, which respectively output the corresponding gray-scale voltages, for example, V8, V20, V43, and V55 of the gray-scale voltages V0 through V63.

In this disclosure, the gray-scale voltage generator 112, according to an exemplary embodiment of the present invention, has been described with respect to the pads 118-1 through 118-4 that respectively output the four gray-scale voltages V8, V20, V43, and V55, for purposes of example only. It is to be understood that the present invention is capable of being embodied using any number of pads or gray-scale voltages to be output via the pads. For example, a plurality of pads may be used to output the gray-scale voltage V0, V1, V62, and V63.

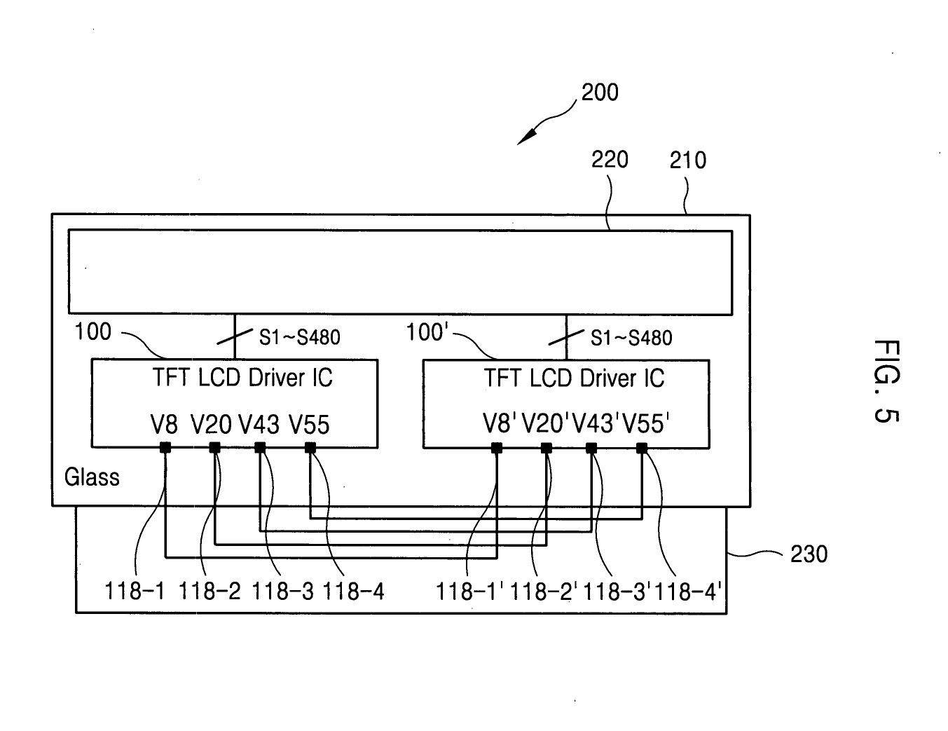

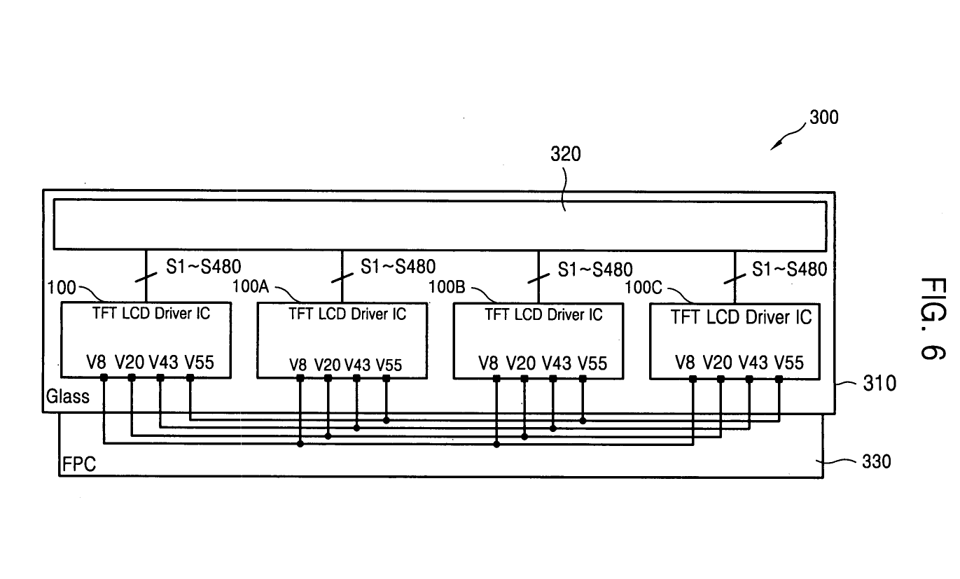

The pads 118-1 through 118-4 are used to connect a plurality of display driving apparatuses in a cascade, for example, as illustrated in FIGS. 5 and 6.

The gray-scale voltages, for example, V1 through V62, of the 64 gray-scale voltages V0 through V63 are generated using a plurality of resistors R.

The 18/6-bit RGB interface 120 is enabled in response to an enable signal ENABLE, and receives image data PD<17:0> in serial in synchronization with a clock signal DOTCLK.

The shift register 122 includes a plurality of latches (for example, flip flops) that are sequentially connected. The shift register 122 receives image data, which are serial output from the 18/6-bit RGB interface 120, in units of 18/6 bits, for example, 6 bits (gray-scale) data×3(R, G, B). The shift register 122 sequentially shifts the received image data to latch the image data in a horizontal scanning unit (or a horizontal scanning period). It will be understood that the shift register 122 converts serial data into parallel data.

The line latch circuit 124 latches parallel image data in 1 horizontal scanning units. The M/AC circuit 126 converts the signals S1 through S480 output from the 480-channel source driver 128 into alternating currents to drive the liquid crystal in a display panel (not shown) with alternating currents. A signal output from the M/AC circuit 126 is used as a selection signal to select one of the gray-scale voltages V0 through V63 output from the gray-scale voltage generator 112.

The 480-channel source driver 128 selects one from the gray-scale voltages V0 through V63 based on signals, e.g., image data, output from the M/AC circuit 126, and generates analog voltage signals S1 through S480 corresponding to the image data, e.g., 6-bit data, output from the M/AC circuit 126, and the source driver 128 supplies the generated analog voltage signals S1 through S480 to data lines (not shown) of the display panel.

The scan line driving circuit 130 drives scan lines (not shown) of the display panel. The timing controller 132 controls the operations of the data line driving circuit 110 and the scan line driving circuit 132. The power source 134 generates voltages for driving the display panel from external reference voltages.

FIG. 5 is a block diagram of a display device 200 with a first and second display panel driving apparatuses 100 and 100′ according to an exemplary embodiment of the present invention. As illustrated in FIGS. 3 through 5, the display device 200 includes a display panel 220 mounted on a glass substrate 210, and the first and second display panel driving apparatuses 100 and 100′.

For example, the display panel 220 may be embodied as a TFT-LCD panel or as an organic light emitting diode (OLED) panel driven by a predetermined display panel driving apparatuses 100 and 100′.

The first and second display panel driving apparatuses 100 and 100′ may be constructed as illustrated in FIG. 3. However, for convenience of explanation, it is assumed that according to a change in a process, temperature, or a voltage, a gray-scale voltage generator 112 of the first display panel driving apparatus 100 generates gray-scale voltages V0 through V63, and the gray-scale voltages V8, V20, V43, and V55 that are used to reduce a block dim, which are respectively output via their corresponding pads 118-1, 118-2, 118-3, and 118-4. Also, it is assumed, in the interests of simplicity, that a gray-scale voltage generator 112 of the second display panel driving apparatus 100′ generates gray-scale voltages V0′ through V63′, and the gray-scale voltages V8′, V20′, and V43′, and V55′ that are used to reduce the block dim, which are respectively output via their corresponding pads 118-1′, 118-2′, 118-3′, and 118-4′.

To reduce the block dim, the pads 118-1, 118-2, 118-3, and 118-4 of the first display panel driving apparatus 100 are respectively connected to the pads 118-1′, 118-2′, 118-3′, and 118-4′ of the second display panel driving apparatus 100′.

The pairs of the pads 118-1 and 118-1′, 118-2 and 118-2′, 118-3 and 118-3′, and 1184 and 118-4′ may be connected via a connector such as, but not limited to, a flexible printed circuit (FPC). It will be understood that any connector should be suitable for implementing the invention.

When the pads 118-1 and 118-1′, 118-2 and 118-2′, 118-3 and 118-3′, and 118-4 and 118-4′ are respectively connected, average voltages can be computed by:

$${Vi}_{AVE} = \frac{Vi + {Vi}^{′}}{2} , \qquad ( 1 )$$

where i is 8, 20, 43, or 55, for example. The averages (or arithmetic means) of the corresponding gray-scale voltages, for example, V8 and V8′, V20 and V20′, V43 and V43′, and V55 and V55′ are applied to the 480-channel source driver 128 of the first display panel driving apparatus 100 and the 480-channel source driver 128′ of the display panel driving apparatus 100′, respectively.

The respective signals S1 through S480 output from the 480-channel source driver 128 of the first display panel driving apparatus 100 are identical to the respective signals S1 through S480 output from the 480-channel source driver 128′ of the second display panel driving apparatus 100′, preventing a block dim from occurring in the display panel 220 driven by the first and second display panel driving apparatuses 100 and 100′.

FIG. 6 is a block diagram of a display device 300 having first through fourth display panel driving apparatuses 100, 100A, 100B, and 100C according to an exemplary embodiment of the present invention.

As illustrated in FIGS. 3, 4, and 6, the display device 300 includes a display panel 320 mounted on a glass substrate 310, and the first through fourth display panel driving apparatuses 100, 100A, 100B, and 100C. The constructions of the first through fourth display panel driving apparatuses 100, 100A, 100B, and 100C are the same as the construction of the display panel driving apparatus 100 of FIG. 3. However, gray-scale voltages Vi (i=0−V63) generated by the gray-scale voltage generator 112 of the first through fourth display panel driving apparatuses 100, 100A, 100B, and 100C, may not be the same.

In accordance with an exemplary embodiment of the present invention, it is possible to minimize the differences between the gray-scale voltages V8, between the gray-scale voltages V20, between the gray-scale voltages V43, and between the gray-scale voltages V55, for example, which are to be applied to 480-channel source drivers 128 of the first through fourth display panel driving apparatuses 100, 100A, 100B, and 100C by connecting, for example, pads 118-1 through 118-4 of the gray-scale voltage generator 112 of the first through fourth display panel driving apparatuses 100, 100A, 100B, and 100C.

The averages (or arithmetic means) of the gray-scale voltages V8, V20, V43 and V55 generated by the gray-scale voltage generator 112 of the first through fourth display panel driving apparatuses 100, 100A, 100B, and 100C are applied to the respective 480-channel source drivers 128 of the first through fourth display panel driving apparatuses 100, 100A, 100B, and 100C.

For instance, when the respective gray-scale voltages V8 generated by the gray-scale voltage generator 112 of the first through fourth display panel driving apparatuses 100, 100A, 100B, and 100C are 3.2 V, 3.1 V, 3.3 V, and 3.0 V, the average of the four gray-scale voltages V8 (in this case, 3.15 V) is applied to all of the respective 480-channel source drivers 128 of the first through fourth display panel driving apparatuses 100, 100A, 100B, and 100C by connecting the pads of the first through fourth display panel driving apparatuses 100, 100A, 100B, and 100C.

The difference between the respective signals Si (i=1−S480) output from the first through fourth display panel driving apparatuses 100, 100A, 100B, and 100C are minimized, reducing a block dim in the display panel 320 driven by the first through fourth display panel driving apparatuses 100, 100A, 100B, and 100C.

In this disclosure, the gray-scale voltages, according to an exemplary embodiment of the present invention has been described with respect to four gray-scale voltages V8, V20, V43, and V55 for purposes of example only. It is to be understood that the present invention is capable of being embodied using any number of pads or gray-scale voltages to be output via the pads. For instance, a plurality of pads may be used to output the gray-scale voltages V0, V1, V62, and V63.

As described above, according to exemplary embodiments of the present invention, it is possible to reduce or cancel a block dim occurring in a display panel of a display device that is driven by a plurality of display panel driving apparatuses, each including a gray-scale voltage generating unit.

Although the exemplary embodiments of the present invention have been described with reference to the accompanying drawings for the purpose of illustration, it is to be understood that the inventive processes and apparatus are not to be construed as limited thereby. It will be readily apparent to by those of ordinary skill in the art that various modifications to the foregoing exemplary embodiments may be made without departing from the scope of the invention as defined by the appended claims, with equivalents of the claims to be included therein.

What is claimed is:

1. A gray-scale voltage generator to buffer each of a plurality of reference voltages and generate a plurality of gray-scale voltages, comprising:
a plurality of output terminals, wherein each of output terminals outputs a gray-scale voltage;
a plurality of buffers, wherein each of the buffers buffers a reference voltage;
a plurality of resistors, wherein each of the resistors is connected between a buffer output terminal of a corresponding buffer of the plurality of the buffers and a corresponding output terminal of the plurality of the output terminals; and
a plurality of pads, wherein each of the pads is connected to a corresponding output terminal of the plurality of the output terminals.

2. A data line driving circuit to drive data lines of a display panel, comprising:
a gray-scale voltage generator to buffer a plurality of reference voltages and output a plurality of gray-scale voltages via a plurality of output terminals; and
a channel source driver to select one from the plurality of the gray-scale voltages based on image data, generate analog voltages corresponding to the image data, and apply the generated analog voltages to the data lines,
wherein the gray-scale voltage generator comprises a plurality of pads, wherein each of the pads outputs a gray-scale voltage, and wherein each of the pads is connected to a corresponding output terminal of the plurality of output terminals.

3. The data line driving circuit of claim 2, wherein the gray-scale voltage generator comprises:
a plurality of buffers, wherein each of the buffers buffers a reference voltage; and
a plurality of resistors, wherein each of the resistors is connected between a buffer output terminal of a corresponding buffer of the plurality of the buffers and a corresponding output terminal of the plurality of the output terminals.

4. A display panel driving apparatus to drive a plurality of scan lines and a plurality of data lines of a display panel, comprising:
a scan line driving circuit to drive the plurality of the scan lines;
a data line driving circuit to drive the plurality of the data lines based on image data; and
a controller to control the scan line driving circuit and the data line driving circuit,
wherein the data line driving circuit comprises:
a gray-scale voltage generator to buffer a plurality of reference voltages and output a plurality of gray-scale voltages via a plurality of output terminals; and
a channel source driver to select one of the gray-scale voltages based on the image data, generate analog voltages corresponding to the image data, and apply the generated analog voltages to the data lines,
wherein the gray-scale voltage generator comprises a plurality of pads, wherein each of the pads outputs a gray-scale voltage, and wherein each of the pads is connected to a corresponding output terminal of the plurality of output terminals.

5. The display panel driving apparatus of claim 4, wherein the gray-scale voltage generator comprises:
a plurality of buffers, wherein each of the buffers buffers a reference voltage; and
a plurality of resistors, wherein each of the resistors is connected between a buffer output terminal of a corresponding buffer of the plurality of the buffers and a corresponding output terminal of the plurality of the output terminals.

6. A display device comprising:
a display panel including a plurality of scan lines and a plurality of data lines; and
a plurality of display panel driving apparatuses,
wherein each of the display panel driving apparatuses comprises:
a data line driving circuit to drive corresponding data lines of the plurality of the data lines; and
a plurality of pads,
wherein each of the pads outputs a gray-scale voltage, and
wherein the pads of each of the display panel driving apparatuses are connected in a cascade.

7. The display device of claim 6, wherein the plurality of the pads of each of the display panel driving apparatuses are connected via a flexible printed circuit.

8. The display device of claim 6, wherein the data line driving circuit comprises:
a gray-scale voltage generator including the plurality of the pads, wherein the gray-scale voltage generator outputs a plurality of gray-scale voltages via a plurality of output terminals; and
a channel source driver to select one of the gray-scale voltages based on image data, generate analog voltages corresponding to the image data, and apply the generated analog voltages to corresponding data lines of the plurality of the data lines.

9. The display device of claim 8, wherein gray-scale voltage generator comprises:
a plurality of buffers, wherein each of the buffers buffers a corresponding reference voltage of the plurality of the reference voltages; and
a plurality of resistors, where each of the resistors is connected between a buffer output of a corresponding buffer of the plurality of the buffers and a corresponding output terminal of the plurality of the output terminals.

10. A display device comprising:
a display panel including a plurality of scan lines and a plurality of data lines;
a first display panel driving apparatus including:
pads, wherein each of the pads outputs a gray-scale voltage; and
a data line driving circuit to drive a plurality of first data lines of the plurality of the data lines; and
a second display panel driving apparatus including:
pads, wherein each of the pads outputs a gray-scale voltage; and
a data line driving circuit to drive a plurality of second data lines of the plurality of the data lines,
wherein the pads of the first display panel driving apparatus are respectively connected to the pads of the second display panel driving apparatus.

11. The display device of claim 10, wherein the pads of the first display panel driving apparatus are respectively connected to the pads of the second display panel driving apparatus via a flexible printed circuit.

12. A method of reducing a block dim in a display device comprising a display panel having a plurality of scan lines and a plurality of data lines, and a plurality of display panel driving apparatuses, each having a plurality of corresponding pads, the method comprising:
connecting the corresponding pads of the plurality of the display panel driving apparatuses in a cascade; and
using the plurality of the display panel driving apparatus, driving corresponding scan lines of the plurality of the scan lines and corresponding data lines of the plurality of the data lines.
